(19) United States
(12) Patent Application Publication
(10) Pub. No.: US 2012/0236934 A1
(43) Pub. Date: Sep. 20, 2012

(54) SIGNALING OF MULTIVIEW VIDEO PLUS DEPTH CONTENT WITH A BLOCK-LEVEL 4-COMPONENT STRUCTURE

(75) Inventors: Ying Chen, San Diego, CA (US); Rong Zhang, San Diego, CA (US); Marta Karczewicz, San Diego, CA (US); Jian Wei, San Diego, CA (US)

(73) Assignee: QUALCOMM INCORPORATED, San Diego, CA (US)

(21) Appl. No.: 13/178,696

(22) Filed: Jul. 8, 2011

Related U.S. Application Data
(60) Provisional application No. 61/454,173, filed on Mar. 18, 2011.

(51) Int. Cl. H04N 7/26

(52) U.S. Cl. 375/240.03; 375/240.08; 375/E07.14; 375/E07.076

(57) ABSTRACT

This disclosure describes techniques for coding 3D video block units. In one example, a video encoder is configured to receive one or more texture components from at least a portion of an image representing a view of three dimensional video data, receive a depth map component for at least the portion of the image, code a block unit indicative of pixels of the one or more texture components for a portion of the image and the depth map component. The coding comprises coding the depth map component relative to at least one of the texture components, and signalling an attribute of the depth map component relative to the one or more texture components.

### CLAIM OF PRIORITY UNDER 35 U.S.C. §119

The present application for patent claims priority to Provisional Application No. 61/454,173 filed Mar. 18, 2011, and assigned to the assignee hereof and hereby expressly incorporated by reference herein.

### TECHNICAL FIELD

This disclosure relates to the field of video coding, e.g., transport of encoded video data.

### BACKGROUND

Digital video capabilities can be incorporated into a wide range of devices, including digital televisions, digital direct broadcast systems, wireless communication devices such as radio telephone handsets, wireless broadcast systems, personal digital assistants (PDAs), laptop or desktop computers, digital cameras, digital recording devices, video gaming devices, video game consoles, and the like. Digital video devices implement video compression techniques, such as MPEG-2, MPEG-4, or H.264/MPEG-4, Part 10, Advanced Video Coding (AVC), to transmit and receive digital video more efficiently. Video compression techniques perform spatial and temporal prediction to reduce or remove redundancy inherent in video sequences.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

Efforts have been made to develop new video coding standards based on H.264/AVC. One such standard is the scalable video coding (SVC) standard, which is the scalable extension to H.264/AVC. Another standard is the multi-view video coding (MVC), which has become the multiview extension to H.264/AVC. A joint draft of MVC is in described in JVT-AB204, “Joint Draft 8.0 on Multiview Video Coding,” 28^{th} JVT meeting, Hannover, Germany, July 2008, available at http://wftp3.itu.int/av-arch/jvt-site/2008_{—}07_Hannover/JVT-AB204.zip. A version of the AVC standard is described in JVT-AD007, “Editors' draft revision to ITU-T Rec. H.264 ISO/IEC 14496-10 Advanced Video Coding—in preparation for ITU-T SG 16 AAP Consent (in integrated form),” 30th JVT meeting, Geneva, CH, February 2009,” available from http://wftp3.itu.int/av-arch/jvt-site/2009_{—}01_Geneva/JVT-AD007.zip. This document integrates SVC and MVC in the AVC specification.

### SUMMARY

In general, this disclosure describes techniques for supporting three-dimensional (3D) video rendering. In particular, the techniques of this disclosure relate to coding and decoding 3D video content in a block-based coding format having four components. This disclosure also proposes signaling techniques for coded block units of video data. The four components include luminance (Y) components and chrominance (Cb and Cr) components as well as a depth component. Luminance (brightness) and chrominance (color) components are collectively referred to herein as “texture” components. Depth components may be from a depth map of an image. In 3D image rendering, depth maps include depth components and can be used for generating virtual views from a provided viewing perspective. An attribute of depth components relative to texture components may be signaled with the coded block unit. Coded block units, also referred to simply as “coded blocks” in this disclosure, may correspond to macroblocks in ITU-T H.264/AVC (Advanced Video Coding) or coding units of High Efficiency Video Coding (HEVC).

In one aspect, a method of processing video data comprises receiving pixels of one or more texture components from at least a portion of an image representing a view of three dimensional video data and receiving a depth map component for at least the portion of the image. The method also comprises coding a block unit comprising pixels of the one or more texture components for a portion of the image and the depth map component, wherein coding comprises coding the depth map component relative to at least one of the texture components. The method further comprises signaling an attribute of the depth map component relative to the one or more texture components, wherein the value for the attribute for the depth map component is different from the value of the one or more texture components.

In some examples, the attribute of the depth component relative to the one or more texture components comprises a resolution of the depth map component relative to a resolution of at least one of the one or more texture components for an entire coded video sequence, for a group of pictures, or for a slice. In other examples, the attribute comprises a quantization parameter difference between the depth map component and one of the one or more texture components for a slice. The attribute may also comprise a flag in the slice level indicating whether the depth map component is present.

In another aspect, a device for encoding data comprises a video encoder configured to receive one or more texture components from at least a portion of an image representing a view of three dimensional video data and receive a depth map component for at least the portion of the image. The video encoder is configured to code a block unit comprising pixels of the one or more texture components for a portion of the image and the depth map component, wherein coding comprises coding the depth map component relative to at least one of the texture components. The video encoder is also configured to signal an attribute of the depth map component relative to the one or more texture components. The value for the attribute for the depth component may be different from the value of the one or more texture components.

In another aspect, a computer-readable medium comprises computer-readable storage medium having stored thereon instructions that, when executed, cause a processor of a video coding device to receive one or more texture components from at least a portion of an image representing a view of three dimensional video data and receive a depth map component for at least the portion of the image. The processor of the video coding device further codes a block unit comprising pixels of the one or more texture components for a portion of the image and the depth map component, wherein coding comprises coding the depth map component relative to at least one of the texture components. The video coding device is further instructed to signal an attribute of the depth map component relative to the one or more texture components, wherein the value for the attribute for the depth map component is different from the value of the one or more texture components.

In another aspect, a device is provided that comprises means for receiving pixels of one or more texture components from at least a portion of an image representing a view of three dimensional video data and means for receiving a depth map component for at least the portion of the image. The device further includes means for coding a block unit comprising pixels of the one or more texture components for a portion of the image and the depth map component, wherein coding comprises coding the depth map component relative to at least one of the texture components. The device also comprises means for signaling an attribute of the depth map component relative to the one or more texture components, wherein the value for the attribute for the depth map component is different from the value of the one or more texture components.

In yet another aspect, a method of decoding video data comprises receiving a coded block unit indicative of pixels of one or more texture components and a depth map component. The method further comprises receiving an attribute of the depth map component relative to the one or more texture components, wherein the value for the attribute for the depth map component is different from the value of a corresponding attribute for the one or more texture components. The method further comprises determining a portion of an image representing a view of three dimensional video data from the one or more texture components, the depth map component, and the attribute.

In another aspect, a device for decoding data comprises a video decoder configured to receive a coded block unit indicative of pixels of one or more texture components and a depth map component, receive an attribute of the depth map component relative to the one or more texture components, wherein the value for the attribute for the depth map component is different from the value of a corresponding attribute for the one or more texture components. The video decoder is further configured to determine a portion of an image representing a view of three dimensional video data from the one or more texture components, the depth map component, and the attribute.

In another aspect, a computer program product comprises a computer-readable storage medium having stored thereon instructions that, when executed, cause a processor of a video decoding device to receive a coded block unit indicative of pixels of one or more texture components and a depth map component. The instructions further cause the processor of the video decoding device to receive an attribute of the depth map component relative to the one or more texture components, wherein the value for the attribute for the depth map component is different from the value of a corresponding attribute for the one or more texture components. The instructions also cause the processor of the video decoding device to determine a portion of an image representing a view of three dimensional video data from the one or more texture components, the depth map component, and the attribute.

In another aspect, a device comprises means for receiving a coded block unit indicative of pixels of one or more texture components and a depth map component. The device also comprises means for receiving an attribute of the depth map component relative to the one or more texture components, wherein the value for the attribute for the depth map component is different from the value of a corresponding attribute for the one or more texture components. The device further comprises means for determining a portion of an image representing a view of three dimensional video data from the one or more texture components, the depth map component, and the attribute.

The techniques described in this disclosure may be implemented in hardware, software, firmware, or any combination thereof. If implemented in software, the software may be executed in a processor, which may refer to one or more processors, such as a microprocessor, application specific integrated circuit (ASIC), field programmable gate array (FPGA), or digital signal processor (DSP), or other equivalent integrated or discrete logic circuitry. Software comprising instructions to execute the techniques may be initially stored in a computer-readable medium and loaded and executed by a processor.

Accordingly, this disclosure also contemplates computer-readable media comprising instructions to cause a processor to perform any of a variety of techniques as described in this disclosure. In some cases, the computer-readable medium may form part of a computer program product, which may be sold to manufacturers and/or used in a device. The computer program product may include the computer-readable medium, and in some cases, may also include packaging materials.

This disclosure may also apply to electromagnetic signals carrying information. For example, an electromagnetic signal may comprise information relating to the full pixel support used to interpolate a value for a sub-integer pixel of a reference sample. In some examples, a signal may be generated from or transmitted by a device implementing the techniques described herein. In other examples, this disclosure may apply to signals that may be received at a device implementing the techniques described herein.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating one example of a video encoding and decoding system that may be used to implement one or more of the techniques of this disclosure.

FIG. 2 is a block diagram illustrating an example of the video encoder of FIG. 1 in further detail.

FIG. 3A is a conceptual diagram illustrating an example of a bitstream structure that may be used in an implementation of one or more of the techniques of this disclosure.

FIG. 3B is a conceptual diagram illustrating an example of a view that may be included in the bitstream structure of FIG. 3A.

FIG. 3C is a conceptual diagram illustrating an example of a Network Abstraction Layer (NAL) unit that may be included in the bitstream structure of FIG. 3A.

FIG. 3D is a conceptual diagram illustrating an example of a coded block that may be included in the bitstream structure of FIG. 3A.

FIG. 4 is a flow diagram illustrating an example operation of a video encoder consistent with this disclosure.

FIG. 5 is a flow diagram illustrating an example operation of a video encoder that utilizes four component coded blocks consistent with this disclosure.

FIG. 6 is a block diagram illustrating an example of the video decoder of FIG. 1 in further detail.

FIG. 7 is a flow diagram illustrating an example operation of a video decoder consistent with this disclosure.

FIG. 8 is a flow diagram illustrating an example operation of a video decoder that utilizes four component coded blocks consistent with this disclosure.

### DETAILED DESCRIPTION

This disclosure describes signaling techniques that may be applied by an encoder and used by a decoder during the inter-prediction stage of a video encoding and/or decoding process. The described techniques are related to the coding of three-dimensional (“3D”) video content. The 3D video content may be represented, for example, as multiview video plus depth (“MVD”) coded blocks. That is, these techniques may be applied to encode a bitstream resembling a multiview video coding (MVC) bitstream, where any or all views of the MVC bitstream may further include depth information, in accordance with the techniques of this disclosure.

More specifically, the techniques involve receipt of at least one two-dimensional image having texture components and depth information. Some texture components and depth information may be encoded together into a single coded block. For example, depth information corresponding to one or more texture components of an image is coded together into a single coded block. An attribute of the depth component relative to the one or more texture components may be signaled in a bitstream including the coded block. That is, these techniques relate to encoding, decoding, and signaling of data used to render three-dimensional video data from two-dimensional video data, based on estimated depth map data for the two-dimensional video data. In this disclosure, the term “coding” may refer to either or both of encoding and/or decoding.

Video conversion based on depth estimation and virtual view synthesis may be used to create 3D image, such as 3D video, applications. In particular, virtual views of a scene may be used to create a 3D view of the scene. Generation of a virtual view of a scene based on an existing view of the scene is conventionally achieved by estimating object depth values before synthesizing the virtual view. Depth estimation is the process of estimating absolute or relative distances between objects and the camera plane from stereo pairs or monoscopic content. Depth information may include information useful in forming three-dimensional video, such as a depth map (e.g., depth values on a per-pixel basis) or a parallax map (e.g., horizontal disparity on a per-pixel basis).

The estimated depth information, usually represented by a grey-level image depth map, can be used to generate arbitrary angle of virtual views using depth image based rendering (DIBR) techniques. Compared to the traditional three-dimensional television (3DTV) systems where multi-view sequences face the challenges of efficient inter-view compression, a depth map based system may reduce the usage of bandwidth by transmitting only one or a few views together with the depth map(s), which can be efficiently encoded. The depth map(s) used in depth map based conversion may be controllable (e.g., through scaling) by end users before it is used in view synthesis. Customized virtual views may be generated with different amount of perceived depth. Also, an estimation of depth can be performed using monoscopic video wherein only a one view 2D content is available.

Techniques described herein may be applied to encode texture components and depth information together into a single coding block. Block based inter-coding is a coding technique that relies on temporal prediction to reduce or remove temporal redundancy between video blocks of successive coded units of a video sequence. The coded units may comprise video frames, slices of video frames, groups of pictures, or another defined unit of encoded video blocks. For inter-coding, a video encoder performs motion estimation and motion compensation to estimate motion between video blocks of two or more adjacent coded units. Using techniques for motion estimation, the video encoder generates motion vectors, which may indicate displacement of video blocks relative to corresponding prediction video blocks in one or more reference frames or other coded units. Using techniques for motion compensation, the video encoder may use the motion vectors to generate prediction video blocks from the one or more reference frames or other coded units. After motion compensation, the video encoder may calculate residual video blocks by subtracting prediction video blocks from the original video blocks being coded.

Conventional blocks of video data typically include one luminance component and two chrominance components. Video encoders typically perform motion estimation relative to the luminance component of a block to calculate a motion vector for the luminance component, then reuse the motion vector when encoding the chrominance components. In accordance with the techniques of this disclosure, a video encoder may further reuse the motion vector calculated for a luminance component of a block that also includes a depth component to encode the depth component. In this manner, the video encoder need not perform a separate motion search to encode depth information for the bitstream.

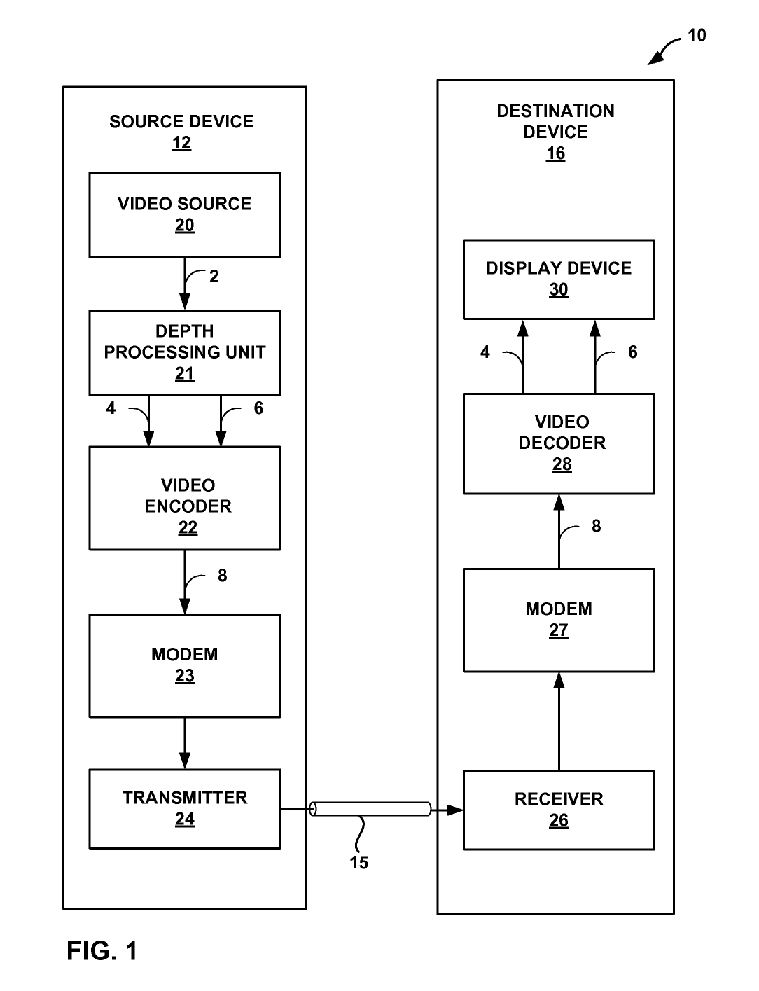

FIG. 1 is a block diagram illustrating one example of a video encoding and decoding system 10 that may be used to implement one or more of the techniques of this disclosure. As shown in FIG. 1, system 10 includes a source device 12 that transmits encoded video to a destination device 16 via a communication channel 15. Source device 12 and destination device 16 may comprise any of a wide range of devices. In some cases, either or both of source device 12 and destination device 16 may comprise wireless communication devices, such as wireless handsets, so-called cellular or satellite radiotelephones, or any wireless devices that can communicate video information over a communication channel 15, in which case communication channel 15 is wireless. The techniques of this disclosure, however, which concern coding blocks of video data that include both texture and depth information, are not necessarily limited to wireless applications or settings. The techniques may also be useful in a wide range of other settings and devices, including devices that communicate via physical wires, optical fibers or other physical or wireless media. In addition, the encoding or decoding techniques may also be applied in a standalone device that does not necessarily communicate with any other device.

In the example of FIG. 1, source device 12 may include a video source 20, depth processing unit 21, video encoder 22, modulator/demodulator (modem) 23, and transmitter 24. Destination device 16 may include a receiver 26, modem 27, video decoder 28, and display device 30. In accordance with this disclosure, video encoder 22 of source device 12 may be configured to apply one or more of the techniques of this disclosure as part of a video encoding process. Similarly, video decoder 28 of destination device 16 may be configured to apply one or more of the techniques of this disclosure as part of a video decoding process.

Video encoder 22 may also apply transform, quantization, and entropy coding processes to further reduce the bit rate associated with communication of residual blocks. Transform techniques may comprise discrete cosine transforms (DCTs) or conceptually similar processes. Alternatively, wavelet transforms, integer transforms, or other types of transforms may be used. In a DCT process, as an example, a set of pixel values may be converted into transform coefficients, which may represent the energy of the pixel values in the frequency domain. Video encoder 22 may also quantize the transform coefficients, which may generally involve a process that reduces the number of bits associated with the corresponding transform coefficient. Entropy coding may include one or more processes that collectively compress data for output to a bitstream, where the compressed data may include, for example, a sequence of coding modes, motion information, coded block patterns, and quantized transform coefficients. Examples of entropy coding include, but are not limited to, context adaptive variable length coding (CAVLC) and context adaptive binary arithmetic coding (CABAC).

A coded video block may be represented by prediction information that can be used to create or identify a predictive block, and a residual block of data that can be applied to the predictive block to recreate the original block. The prediction information may comprise the one or more motion vectors that are used to identify the predictive block of data. Using the motion vectors, video decoder 28 may be able to reconstruct the predictive blocks that were used to code the residual blocks. Thus, given a set of residual blocks and a set of motion vectors (and possibly some additional syntax), video decoder 28 can reconstruct a video frame that was originally encoded. Inter-coding based on motion estimation and motion compensation can achieve relatively high amounts of compression without excessive data loss, because successive video frames or other types of coded units are often similar. An encoded video sequence may comprise blocks of residual data, motion vectors (when inter-prediction encoded), indications of intra-prediction modes for intra-prediction, attributes of depth components relative to texture components, and possibly other data, such as types of syntax elements.

Video encoder 22 may also utilize intra-prediction techniques to encode video blocks relative to neighboring video blocks of a common frame or slice. In this manner, video encoder 22 may spatially predict the blocks. Video encoder 22 may be configured with a variety of intra-prediction modes, which generally correspond to various spatial prediction directions. As with motion estimation, video encoder 22 may be configured to select an intra-prediction mode based on a luminance component of a block, then reuse the intra-prediction mode to encode chrominance components of the block. Moreover, in accordance with the techniques of this disclosure, video encoder 22 may reuse the intra-prediction mode to encode a depth component of the block.

By reusing motion and intra-prediction mode information to encode a depth component of a block, these techniques may simplify the process of encoding depth maps. Moreover, these techniques may improve bitstream efficiency. That is, the bitstream need only include one indication of motion information (or intra-prediction mode information) for a block including texture and depth components, rather than separate sets of motion information (or intra-prediction mode information) for texture and depth components.

Again, the illustrated system 10 of FIG. 1 is merely one example. The various techniques of this disclosure may be performed by any encoding device that supports block-based predictive encoding, or by any decoding device that supports block-based predictive decoding. Source device 12 and destination device 16 are merely examples of such coding devices in which source device 12 generates coded video data for transmission to destination device 16. In some cases, devices 12 and 16 may operate in a substantially symmetrical manner, such that each of devices 12 and 16 include video encoding and decoding components. Hence, system 10 may support one-way or two-way video transmission between video devices 12 and 16, e.g., for video streaming, video playback, video broadcasting, or video telephony.

Video source 20 of source device 12 may include a video capture device, such as a video camera, a video archive containing previously captured video, or a video feed from a video content provider. As a further alternative, video source 20 may generate computer graphics-based data as the source video, or a combination of live video, archived video, and/or computer-generated video. In some cases, if video source 20 is a video camera, source device 12 and destination device 16 may form so-called camera phones or video phones, or other mobile devices configured to manipulate video data, such as tablet computing devices. In each case, the captured, pre-captured or computer-generated video may be encoded by video encoder 22. Video source 20 captures a view 2 and provides it to depth processing unit 21.

Video source 20 provides view 2 to depth processing unit 21 for calculation of depth image for objects in view 2. Depth processing unit 21 may be configured to automatically calculate depth values for objects in the image of view 2. For example, depth processing unit 21 may calculate depth values for objects based on luminance information. In some examples, depth processing unit 21 may be configured to receive depth information from a user. In some examples, video source 20 may capture two views of a scene at different perspectives, and then calculate depth information for objects in the scene based on disparity between the objects in the two views. In various examples, video source 20 may comprise a standard two-dimensional camera, a two camera system that provides a stereoscopic view of a scene, a camera array that captures multiple views of the scene, or a camera that captures one view plus depth information.

Depth processing unit 21 may pass texture components 4 and depth information 6 to video encoder 22. Depth processing unit 21 may also pass view 2 to video encoder 22. Depth information 6 may comprise a depth map image for view 2. A depth map may comprise a map of depth values for each region of pixels associated with an area (e.g., block, slice, or frame) to be displayed. A region of pixels may be a single pixel or a group of one or more pixels. Some examples of depth maps have one depth component per pixel. In other examples, there may be multiple depth components per pixel.

In some examples, the depth map is estimated. When more than one view is present, stereo matching may be used to estimate depth maps when more than one view is available. However, in 2D to 3D conversion, estimating depth may be more difficult. Nevertheless, depth map estimated by various methods may be used for 3D rendering based on Depth-Image-Based Rendering (DIBR).

Although video source 20 may provide multiple views of a scene, depth processing unit 21 may calculate depth information based on the multiple views and source device 12 may generally transmit one view plus depth information for each view of a scene.

When view 2 is a digital still picture, video encoder 22 may be configured to encode view 2 as, for example, a Joint Photographic Experts Group (JPEG) image. When view 2 is a frame of video data, video encoder 22 may be configured to encode first view 50 according to a video coding standard such as, for example Motion Picture Experts Group (MPEG), International Organization for Standardization (ISO)/International Electrotechnical Commission (IEC) MPEG-1 Visual, ISO/IEC MPEG-2 Visual, ISO/IEC MPEG-4 Visual, International Telecommunication Union (ITU) H.261, ITU-T H.262, ITU-T H.263, ITU-T H.264/MPEG-4, H.264 Advanced Video Coding (AVC), the upcoming High Efficiency Video Coding (HEVC) standard (also referred to as H.265), or other video encoding standards. Video encoder 22 may include depth information 6 along with the encoded image to form coded block 8, which includes encoded image data along with depth information 6. Video encoder 22 passes coded block 8 to transmitter 24. Coded block 8 may be transferred to receiver 26 in a bitstream including signaling information along with coded block 8.

The encoded video information may include texture components 4 and depth information 6. Texture components 4 may include luminance (luma) and chrominance (chroma) components of video information. Luma components generally describe brightness, while chrominance components generally describe hues of color. Depth processing unit 21 may extract depth information 6 from a depth map of video 2. Video encoder 22 may encode texture components 4 and depth information 6 into a single coded block 8 of encoded video data. Likewise, video encoder 22 may encode the block such that motion or intra-prediction mode information for the luma component is reused for the chroma components and the depth component.

Coded block 8 may be modulated by modem 23 according to a communication standard, e.g., such as code division multiple access (CDMA) or another communication standard, and transmitted to destination device 16 via transmitter 24 and communication channel 15. Modem 23 may include various mixers, filters, amplifiers or other components designed for signal modulation. Transmitter 24 may include circuits designed for transmitting data, including amplifiers, filters, and one or more antennas. In some examples, rather than transmitting over a communication channel, source device 12 stores encoded video data, including blocks having texture and depth components, onto a storage medium, such as a digital video disc (DVD), Blu-ray disc, flash drive, or the like.

Receiver 26 of destination device 16 receives information over communication channel 15, and modem 27 demodulates the information. Like transmitter 24, receiver 26 may include circuits designed for receiving data, including amplifiers, filters, and one or more antennas. In some instances, transmitter 24 and/or receiver 26 may be incorporated within a single transceiver component that includes both receive and transmit circuitry. Modem 27 may include various mixers, filters, amplifiers or other components designed for signal demodulation. In some instances, modems 23 and 27 may include components for performing both modulation and demodulation.

Again, the video encoding process performed by video encoder 22 may implement one or more of the techniques described herein during inter-prediction encoding, which may include motion estimation and motion compensation, and intra-prediction encoding. The video decoding process performed by video decoder 28 may also perform such techniques during a motion compensation stage of the decoding process.

The term “coder” is used herein to refer to a specialized computer device or apparatus that performs video encoding or video decoding. The term “coder” generally refers to any video encoder, video decoder, or combined encoder/decoder (codec). The term “coding” refers to encoding or decoding. The terms “coded block,” “coded block unit,” or “coded unit” may refer to any independently decodable unit of a video frame such as an entire frame, a slice of a frame, a block of video data, or another independently decodable unit defined according to the coding techniques used.

Display device 30 displays the decoded video data to a user, and may comprise any of a variety of one or more display devices such as a cathode ray tube (CRT), a liquid crystal display (LCD), a plasma display, an organic light emitting diode (OLED) display, or another type of display device. In some examples, display device 30 corresponds to a device capable of three-dimensional playback. For example, display device 30 may comprise a stereoscopic display, which is used in conjunction with eyewear worn by a viewer. The eyewear may comprise active glasses, in which case display device 30 rapidly alternates between images of different views synchronously with alternate shuttering of lenses of the active glasses. Alternatively, the eyewear may comprise passive glasses, in which case display device 30 displays images from different views simultaneously, and the passive glasses may include polarized lenses that are generally polarized in orthogonal directions to filter between the different views.

In the example of FIG. 1, communication channel 15 may comprise any wireless or wired communication medium, such as a radio frequency (RF) spectrum or one or more physical transmission lines, or any combination of wireless and wired media. Communication channel 15 may form part of a packet-based network, such as a local area network, a wide-area network, or a global network such as the Internet. Communication channel 15 generally represents any suitable communication medium, or collection of different communication media, for transmitting video data from source device 12 to destination device 16. Communication channel 15 may include routers, switches, base stations, or any other equipment that may be useful to facilitate communication from source device 12 to destination device 16.

Video encoder 22 and video decoder 28 may operate according to a video compression standard, such as the ITU-T H.264 standard, alternatively described as MPEG-4, Part 10, Advanced Video Coding (AVC). Additional video compression standards that are based on the ITU H.264/AVC standard that may be used by video encoder 22 and video decoder 28 include the scalable video coding (SVC) standard, which is a scalable extension to the ITU H.264/AVC standard. Another standard with video encoder 22 and video decoder 28 may operate according to includes the multi-view video coding (MVC) standard, which is a multi-view extension to the ITU H.264/AVC standard. The techniques of this disclosure, however, are not limited to any particular video coding standard.

In some aspects, video encoder 22 and video decoder 28 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 22 and video decoder 28 each may be implemented as one or more microprocessors, digital signal processors (DSPs), application specific integrated circuits (ASICs), field programmable gate arrays (FPGAs), discrete logic, software, hardware, firmware or any combinations thereof. When any or all of the techniques of this disclosure are implemented in software, an implementing device may further include hardware for storing and/or executing instructions for the software, e.g., a memory for storing the instructions and one or more processing units for executing the instructions. Each of video encoder 22 and video decoder 28 may be included in one or more encoders or decoders, either of which may be integrated as part of a combined codec that provides encoding and decoding capabilities in a respective mobile device, subscriber device, broadcast device, server, or the like.

A video sequence typically includes a series of video frames, also referred to as video pictures. Video encoder 22 operates on video blocks within individual video frames in order to encode the video data. The video blocks may have fixed or varying sizes, and may differ in size according to a specified coding standard. Each video frame includes a series of one or more slices. In the ITU-T H.264 standard, for example, each slice may include a series of macroblocks, which may be arranged into sub-blocks. The H.264 standard supports intra prediction in various block sizes for two dimensional (2D) video encoding, such as 16 by 16, 8 by 8, or 4 by 4 for luma components, and 8×8 for chroma components, as well as inter prediction in various block sizes, such as 16 by 16, 16 by 8, 8 by 16, 8 by 8, 8 by 4, 4 by 8 and 4 by 4 for luma components and corresponding scaled sizes for chroma components. Video blocks may comprise blocks of pixel data, or blocks of transformation coefficients, e.g., following a transformation process such as discrete cosine transform (DCT) or a conceptually similar transformation process. These techniques may be extended to 3D video using four component block units.

Smaller video blocks can provide better resolution, and may be used for locations of a video frame that include high levels of detail. In general, macroblocks and the various sub-blocks may be considered to be video blocks. In addition, a slice may be considered to be a series of video blocks, such as macroblocks and/or sub-blocks. Each slice may be an independently decodable unit of a video frame. Alternatively, frames themselves may be decodable units, or other portions of a frame may be defined as decodable units.

The 2D macroblocks of the ITU-T H.264 standard may be extended to 3D by encoding depth information 6 from a depth map or parallax map together with associated luma and chroma components (that is, texture components 4) for that video frame or slice. Parallax mapping (also referred to as virtual displacement mapping or offset mapping) displaces texture components at a pixel location based on a function of a view angle and a height map at the pixel location. Video encoder 22 may encode the depth information as monochromatic video. This monochromatic video encoded depth information may be encoded in a block unit along with the luma and chroma components.

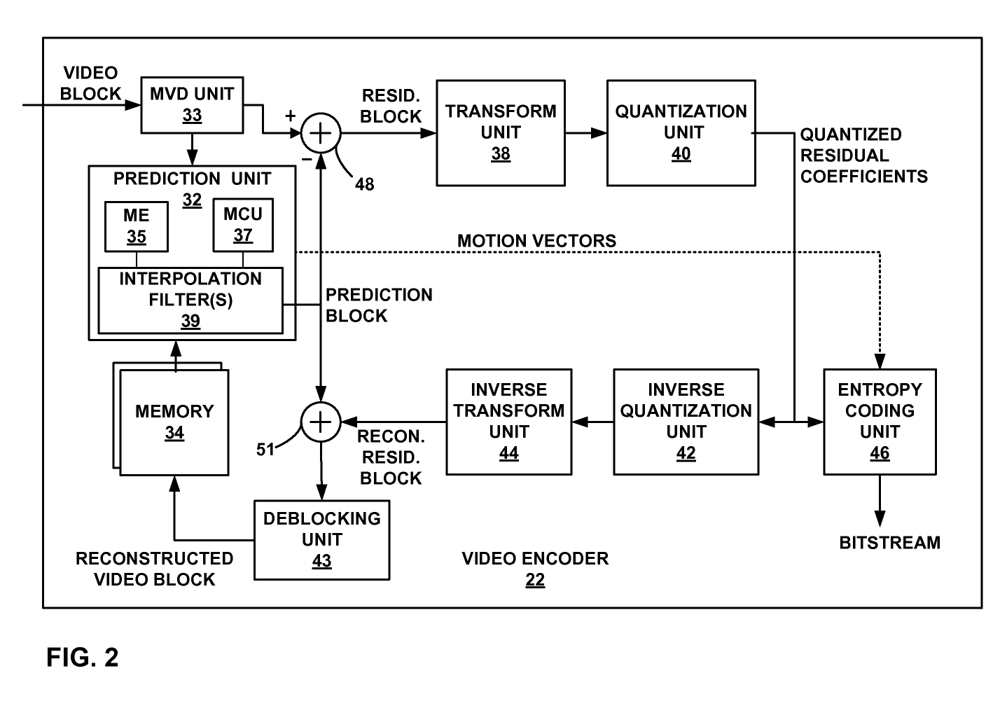

To encode the video blocks, such as coded block 8, video encoder 22 performs intra- or inter-prediction to generate one or more prediction blocks. Video encoder 22 subtracts the prediction blocks from the original video blocks to be encoded to generate residual blocks. Thus, the residual blocks may represent pixel-by-pixel differences between the blocks being coded and the prediction blocks. Video encoder 22 may perform a transform on the residual blocks to generate blocks of transform coefficients. Following intra- or inter-based predictive coding and transformation techniques, video encoder 22 may quantize the transform coefficients. Quantization generally refers to a process in which coefficients are quantized to possibly reduce the amount of data used to represent the coefficients. Following quantization, entropy coding may be performed according to an entropy coding methodology, such as context adaptive variable length coding (CAVLC) or context adaptive binary arithmetic coding (CABAC). Additional details of an encoding process performed by video encoder 22 are described below with respect to FIG. 2.

Efforts are currently in progress to develop a new video coding standard, currently referred to as High Efficiency Video Coding (HEVC). The upcoming standard is also referred to as H.265. The standardization efforts are based on a model of a video coding device referred to as the HEVC Test Model (HM). The HM presumes several capabilities of video coding devices over devices according to, e.g., ITU-T H.264/AVC. For example, whereas H.264 provides nine intra-prediction encoding modes, HM provides as many as thirty-three intra-prediction encoding modes. HEVC may be extended to support the four component block units as described herein.

HM refers to a block of video data as a coding unit (CU). Syntax data within a bitstream may define a largest coding unit (LCU), which is a largest coding unit in terms of the number of pixels. In general, a CU has a similar purpose to a macroblock of H.264, except that a CU does not have a size distinction. The four-component coded block 8 may be a CU according to the HM standard. Thus, a CU may be split into sub-CUs. In general, references in this disclosure to a CU may refer to a largest coding unit (LCU) of a picture or a sub-CU of an LCU. An LCU may be split into sub-CUs, and each sub-CU may be split into sub-CUs. Syntax data for a bitstream may define a maximum number of times an LCU may be split, referred to as CU depth. Accordingly, a bitstream may also define a smallest coding unit (SCU). This disclosure also uses the term “block” to refer to any of a CU, prediction unit (PU), or transform unit (TU).

An LCU may be associated with a quadtree data structure. In general, a quadtree data structure includes one node per CU, where a root node corresponds to the LCU. If a CU is split into four sub-CUs, the node corresponding to the CU includes four leaf nodes, each of which corresponds to one of the sub-CUs. Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs.

A CU that is not split may include one or more prediction units (PUs). In general, a PU represents all or a portion of the corresponding CU, and includes data for retrieving a reference sample for the PU. For example, when the PU is intra-mode encoded, the PU may include data describing an intra-prediction mode for the PU. As another example, when the PU is inter-mode encoded, the PU may include data defining a motion vector for the PU. The data defining the motion vector may describe, for example, a horizontal component of the motion vector, a vertical component of the motion vector, a resolution for the motion vector (e.g., one-quarter pixel precision or one-eighth pixel precision), a reference frame to which the motion vector points, and/or a reference list (e.g., list 0 or list 1) for the motion vector. The motion vector may also be treated as having different resolutions for texture components 4 and depth information 6. Data for the CU defining the PU(s) may also describe, for example, partitioning of the CU into one or more PUs. Partitioning modes may differ between whether the CU is uncoded, intra-prediction mode encoded, or inter-prediction mode encoded.

A CU having one or more PUs may also include one or more transform units (TUs). Following prediction using a PU, video encoder 22 may calculate a residual value for the portion of the CU corresponding to the PU. The residual value may be transformed, scanned, and quantized. A TU is not necessarily limited to the size of a PU. Thus, TUs may be larger or smaller than corresponding PUs for the same CU. In some examples, the maximum size of a TU may correspond to the size of the corresponding CU.

As noted above, intra-prediction includes predicting a PU of a current CU of a picture from previously coded CUs of the same picture. More specifically, video encoder 22 may intra-predict a current CU of a picture using a particular intra-prediction mode. An HM encoder may be configured with up to thirty-three intra-prediction modes. Therefore, to support a one-to-one mapping between directional intra-prediction modes and directional transforms, HM encoders and decoders would need to store 66 matrices for each supported transform size. Furthermore, the block sizes for which all thirty-three intra-prediction modes are supported may be relatively large blocks, e.g., 32×32 pixels, 64×64 pixels, or even larger.

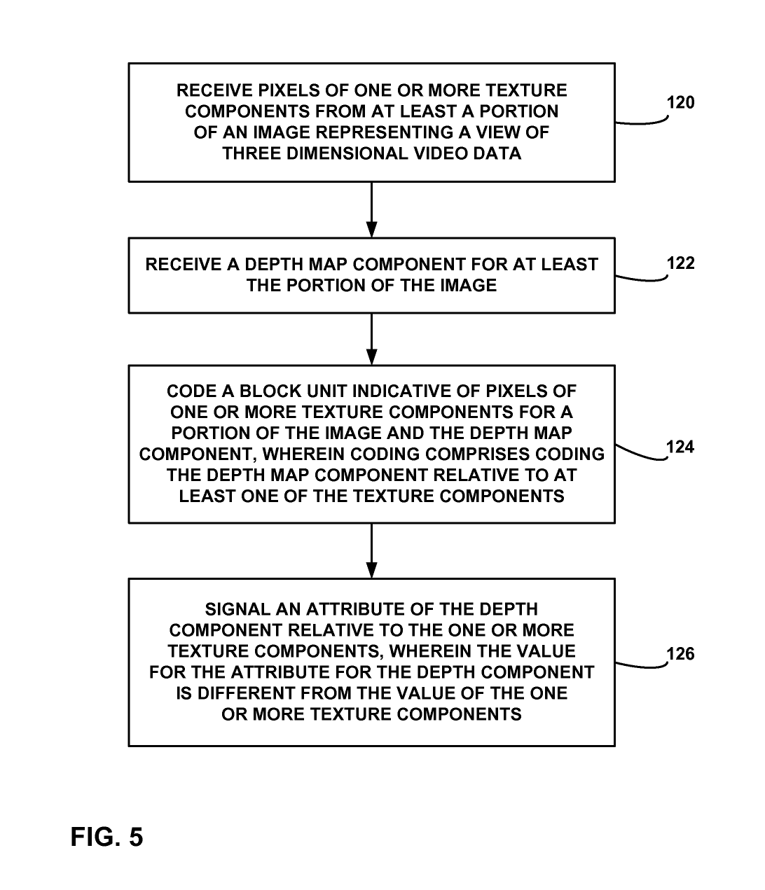

In destination device 16, video decoder 28 receives the encoded video data. Video decoder 28 entropy decodes the received video data, such as coded block 8, according to an entropy coding methodology, such as CAVLC or CABAC, to obtain the quantized coefficients. Video decoder 28 applies inverse quantization (de-quantization) and inverse transform functions to reconstruct the residual block in the pixel domain. Video decoder 28 also generates a prediction block based on control information or syntax information (e.g., coding mode, motion vectors, syntax that defines filter coefficients and the like) included in the encoded video data. Video decoder 28 may calculate a sum of the prediction block and the reconstructed residual block to produce a reconstructed video block for display. Additional details of an example decoding process performed by video decoder 28 are described below with respect to FIG. 5.

As described herein, Y may represent luminance, Cb and Cr may represent two different values of chrominance of a three-dimensional YCbCr color space (e.g., blue and red hues), and D may represent depth information. In some examples, each pixel location may actually define three pixel values for a three-dimensional color space and one pixel value for the depth of the pixel location. In other examples, there may be different numbers of luma components per a chroma component. For example, there may be four luma components per chroma component. Additionally, the depth and texture components may have different resolutions. In such an example, there may not be a one-to-one relationship between texture components (for example, luma components) and depth components. The techniques of this disclosure, however, may refer to prediction with respect to one dimension for purposes of simplicity. To the extent that techniques are described with respect to pixel values in one dimension, similar techniques may be extended to the other dimensions. In particular, in accordance with one aspect of this disclosure, video encoder 22 and/or video decoder 28 may obtain a block of pixels, wherein the block of pixels includes texture components 4 and depth information 6.

In some examples, video encoder 22 and video decoder 28 may use one or more interpolation filtering techniques during motion compensation. That is, video encoder 22 and/or video decoder 28 may apply an interpolation filter to filter support comprising sets of full integer pixel positions.

Video decoder 28 of destination device 16 may receive the coded block 8 as part of an encoded video bitstream along with additional information, including one or more attributes of the depth component relative to the one or more texture components. Video decoder 28 may render video data for 3D playback based on the coded block 8 and one or more attributes. In accordance with the techniques of this disclosure, and as discussed in greater detail below, the signaled attributes may include an indication of resolution of the depth component relative to resolution of the luminance component, and may be for an entire coded video sequence, for a group of pictures, or for a slice. The attribute may also be a quantization parameter difference between the depth map component and one of the one or more texture components for a slice. The attribute may also be a flag in the slice level indicating whether the depth map component is present. The attributes may be signaled at the sequence level (e.g., in a sequence parameter set (SPS) data structure), the picture level (e.g., in a picture parameter set (PPS) data structure or frame header), the slice level (e.g., in a slice header), or the block level (e.g., in a block header).

In accordance with another aspect of this disclosure, video encoder 22 may determine one or more texture components from at least a portion of an image and obtain depth information for the portion of the image. Video encoder 22 may also form a block unit comprising pixels of the one or more texture components and a depth component based on the depth information. Furthermore, video encoder 22 may signal an attribute of the depth component relative to the one or more texture components, wherein the value for the attribute for the depth component is different from the value of the one or more texture components.

Video encoder 22 may provide an indication of the attribute of the depth component (such as depth information 6) relative to the one or more texture components 4 to video decoder 28, generally as information included in the bitstream. The attribute of the depth information 6 relative to one or more texture components 4 may include a resolution of the depth information 6 relative to a resolution of the one or more texture components 4.

The attribute of the depth information 6 relative to one or more texture components 4 may further be (additionally or alternatively) a quantization parameter difference between the depth component and one of the one or more texture components. In another example, the attribute may be comprises a delta quantization parameter for the depth component.

The attributes may be indications provided in one or more of a prediction unit level, a coding unit level, a frame level, a slice level, or a sequence level, wherein each level is related to the current block of pixels (for example, image 2). In some examples, the indication may be provided in a sequence parameter set (SPS) or picture parameter set (PPS). Video encoder 22 may output the indication of the attribute to another device as part of an encoded bitstream.

In this manner, video decoder 28 represents an example of a decoder configured to receive a block unit comprising pixels of one or more texture components and a depth component at a video decoder. The video decoder may also receive an attribute of the depth component relative to the one or more texture components, wherein the value for the attribute for the depth component is different from the value of the one or more texture components. The video decoder may also determine a portion of an image from the one or more texture components, the depth component, and the attribute.

FIG. 2 is a block diagram illustrating an example of the video encoder 22 of FIG. 1 in further detail. Video encoder 22 may encode block units having four components, including three texture components and a depth component, consistent with the techniques of this disclosure. Video encoder 22 is one example of a specialized video computer device or apparatus referred to herein as a “coder.” As shown in FIG. 2, video encoder 22 corresponds to video encoder 22 of source device 12. However, in other examples, video encoder 22 may correspond to a different device. In further examples, other units (such as, for example, other encoder/decoder (CODECS)) can also perform similar techniques to those performed by video encoder 22.

Video encoder 22 may perform intra- and inter-coding of blocks within video frames, although intra-coding components are not shown in FIG. 2 for ease of illustration. Intra-coding relies on spatial prediction to reduce or remove spatial redundancy in video within a given video frame. Inter-coding relies on temporal prediction to reduce or remove temporal redundancy in video within adjacent frames of a video sequence. Intra-mode (I-mode) may refer to the spatial-based compression mode. Inter-modes such as a prediction (P-mode) or a bi-directional (B-mode) may refer to the temporal based compression modes. The techniques of this disclosure apply during inter-coding and intra-coding. However, for simplicity and ease of illustration, intra-coding units such as a spatial prediction unit are not illustrated in FIG. 2.

As shown in FIG. 2, video encoder 22 receives a video block within a video frame to be encoded. For example, video encoder 22 may receive texture components 4 and depth components 6. In the example of FIG. 2, video encoder 22 includes a prediction coding unit (MCU) 32, multi-view video plus depth (MVD) unit 33, memory 34, an adder 48, a transform unit 38, a quantization unit 40, and an entropy coding unit 46. For video block reconstruction, video encoder 22 also includes an inverse quantization unit 42, an inverse transform unit 44, an adder 51, and a deblocking unit 43. Deblocking unit 43 may be a deblocking filter that may filter block boundaries to remove blockiness artifacts from reconstructed video. If included in video encoder 22, deblocking unit 43 would typically filter the output of adder 51. In one example, as shown in FIG. 2, transform unit 38 may be a functional block, not a “TU” in terms of HEVC. Deblocking unit 43 may determine deblocking information for the one or more texture components. Deblocking unit 43 may also determine deblocking information for the depth map component. In some examples, the deblocking information for the one or more texture components may be different than the deblocking information for the depth map component.

Multi-view video plus depth (MVD) unit 33 receives the video block (labeled “VIDEO BLOCK” in FIG. 2) comprising texture components 4 and depth information 6. MVD unit 33 provides functionality to video encoder 22 to encode depth information 6 in a block unit along with texture components 4. MVD unit 33 enables the four component YUV-D format of block units for coding of 3D video content. The MVD unit 33 may provide the texture components 4 and depth information 6, either combined or separately, to prediction unit 32 in a format that enables prediction unit 32 to process depth information 6. MVD unit 33 may also signal to transform unit 38 that depth information 6 is included with the video block. In other examples, each unit of video encoder 22, such as prediction unit 32, transform unit 38, quantization unit 40, entropy coding unit 46, etc., comprises functionality to process depth information 6 in addition to texture components 4.

In general, video encoder 22 may encode the depth information in a manner similar to chrominance information, in that motion compensation unit 37 may be configured to reuse motion vectors calculated for a luminance component of a block when calculating a predicted value for a depth component of the same block. Similarly, an intra-prediction unit of video encoder 22 may be configured to use an intra-prediction mode selected for the luminance component (that is, based on analysis of the luminance component) when encoding the depth component using intra-prediction.

Prediction unit 32 may include a motion estimation (ME) unit 35 and a motion compensation (MC) unit 37. Prediction unit 32 may predict depth information for pixel locations as well as for texture components. One or more interpolation filters 39 (referred to herein as “filter 39”) may be included in prediction unit 32 and may be invoked by one or both of ME unit 35 and MC unit 37 to perform interpolation as part of motion estimation and/or motion compensation. Interpolation filter 39 may actually represent a plurality of different filters to facilitate numerous different types of interpolation and interpolation-type filtering. Thus, prediction unit 32 may include a plurality of interpolation or interpolation-like filters.

During the encoding process, video encoder 22 receives a video block to be coded (labeled “VIDEO BLOCK” in FIG. 2), and prediction unit 32 performs inter-prediction coding to generate a prediction block (labeled “PREDICTION BLOCK” in FIG. 2). The prediction block may include both texture components 4 and depth information 6. Specifically, ME unit 35 may perform motion estimation to identify the prediction block in memory 34, and MC unit 37 may perform motion compensation to generate the prediction block.

Motion estimation is typically considered the process of generating motion vectors, which estimate motion for video blocks. A motion vector, for example, may indicate the displacement of a prediction block within a prediction or reference frame (or other coded unit, e.g., slice) relative to the block to be coded within the current frame (or other coded unit). The motion vector may have full-integer or sub-integer pixel precision. For example, both a horizontal component and a vertical component of the motion vector may have respective full integer components and sub-integer components. The reference frame (or portion of the frame) may be temporally located prior to or after the video frame (or portion of the video frame) to which the current video block belongs. Motion compensation is typically considered the process of fetching or generating the prediction block from memory 34, which may include interpolating or otherwise generating the predictive data based on the motion vector determined by motion estimation.

ME unit 35 calculates at least one motion vector for the video block to be coded by comparing the video block to reference blocks of one or more reference frames (e.g., a previous and/or subsequent frame). Data for the reference frames may be stored in memory 34. ME unit 35 may perform motion estimation with fractional pixel precision, sometimes referred to as fractional pixel, fractional pel, sub-integer, or sub-pixel motion estimation. In fractional pixel motion estimation, ME unit 35 may calculate a motion vector that indicates displacement to a location other than an integer pixel location. Thus, the motion vector may have fractional pixel precision, e.g., one-half-pixel precision, one-quarter-pixel precision, one-eighth pixel precision, or other fractional pixel precisions. In this manner, fractional pixel motion estimation allows prediction unit 32 to estimate motion with higher precision than integer-pixel (or full-pixel) locations, and thus, prediction unit 32 may generate a more accurate prediction block. Fractional pixel motion estimation may allow prediction unit 32 to predict depth information at a first resolution and to predict the texture components at a second resolution. For example, the texture components may be predicted to a full-pixel precision while the depth information is predicted to one-half-pixel precision. In other examples, other resolutions of the motion vector may be used for depth information and texture components.

ME unit 35 may invoke filter(s) 39 for any necessary interpolations during the motion estimation process. In some examples, memory 34 may store interpolated values for sub-integer pixels, which may be calculated by, e.g., summer 51 using filter(s) 39. For example, summer 51 may apply filter(s) 39 to reconstructed blocks that are to be stored in memory 34.

To perform fractional pixel motion compensation, MC unit 37 may perform interpolation (sometimes referred to as interpolation filtering) in order to generate data at sub-pixel resolution (referred to herein as sub-pixel or fractional pixel values). MC unit 37 may invoke filter(s) 39 for this interpolation. In this manner, prediction unit 32 may calculate values for sub-integer pixel positions of a reference block, which may then be used to produce a predictive block of video data for the depth and texture components of the 3D block unit.

Once the motion vector for the video block to be coded is calculated by ME unit 35, MC unit 37 generates the prediction video block associated with that motion vector. MC unit 37 may fetch the prediction block from memory 34 based on the motion vector determined by MC unit 35. In the case of a motion vector with fractional pixel precision, MC unit 37 may filter data from memory 34 to interpolate such data to sub-pixel resolution, e.g., invoking filter(s) 39 for this process.

In some cases, the full-integer pixel positions corresponding to the filter coefficients used to interpolate such data to sub-pixel resolution may be indicated as one or more interpolation syntax elements to entropy coding unit 46 for inclusion in the coded bitstream. Similarly, the interpolation filtering technique or mode that was used to generate the sub-pixel prediction data may also be indicated as one or more interpolation syntax elements to entropy coding unit 46 for inclusion in the coded bitstream. In some cases, the relative resolution of the depth image to the resolution of the luma component may be indicated as one or more interpolation syntax elements to entropy coding unit 46 for inclusion in the coded bitstream. In some examples, the relative resolution may be indicated as an attribute at the sequence level. Other examples may provide an indication of the relative resolution of the depth image to the resolution of the Cb and Cr components of the image as one or more interpolation syntax elements to entropy coding unit 46 for inclusion in the coded bitstream.

Once prediction unit 32 has generated the prediction block, video encoder 22 forms a residual video block (labeled “RESID. BLOCK” in FIG. 2) by subtracting the prediction block from the original video block being coded. This subtraction may occur between texture components in the original video block and texture components in the prediction block, as well as for depth information in the original video block or depth map from depth information in the prediction block. Adder 48 represents the component or components that perform this subtraction operation.

Transform unit 38 applies a transform, such as a discrete cosine transform (DCT) or a conceptually similar transform, to the residual block, producing a video block comprising residual transform block coefficients. It should be understood that transform unit 38 represents the component of video encoder 22 that applies a transform to residual coefficients of a block of video data, in contrast to a TU of a CU as defined by HEVC. Transform unit 38, for example, may perform other transforms, such as those defined by the H.264 standard, which are conceptually similar to DCT. Such transforms may include, for example, directional transforms (such as Karhunen-Loeve theorem transforms), wavelet transforms, integer transforms, sub-band transforms, or other types of transforms. In any case, transform unit 38 applies the transform to the residual block, producing a block of residual transform coefficients. Transform unit 38 may apply the same type of transform to both the texture components and the depth information in corresponding residual blocks. There will be separate residual blocks for each texture and depth component. The transform may convert the residual information from a pixel domain to a frequency domain.

Quantization unit 40 quantizes the residual transform coefficients to further reduce bit rate. The quantization process may reduce the bit depth associated with some or all of the coefficients. Quantization unit 40 may quantize a depth image coding residue. Following quantization, entropy coding unit 46 entropy codes the quantized transform coefficients. For example, entropy coding unit 46 may perform CAVLC, CABAC, or another entropy coding methodology.

Entropy coding unit 46 may also code one or more motion vectors and support information obtained from prediction unit 32 or other component of video encoder 22, such as quantization unit 40. The one or more prediction syntax elements may include a coding mode, data for one or more motion vectors (e.g., horizontal and vertical components, reference list identifiers, list indexes, and/or motion vector resolution signaling information), an indication of a used interpolation technique, a set of filter coefficients, an indication of the relative resolution of the depth image to the resolution of the luma component, a quantization matrix for the depth image coding residue, deblocking information for the depth image, or other information associated with the generation of the prediction block. These prediction syntax elements may be provided in the sequence level or in the picture level.

The one or more syntax elements may also include a quantization parameter (QP) difference between the luma component and the depth component. The QP difference may be signaled at the slice level. Other syntax elements may also be signaled at a coded block unit level, including a coded block pattern for the depth information, a delta QP for the depth information, a motion vector difference, or other information associated with the generation of the prediction block. The motion vector difference may be signaled as a delta value between a target motion vector and a motion vector of the texture components, or as a delta value between the target motion vector (that is, the motion vector of the block being coded) and a predictor from neighboring motion vectors for the block (e.g., a PU of a CU). Following the entropy coding by entropy coding unit 46, the encoded video and syntax elements may be transmitted to another device or archived (for example, in memory 34) for later transmission or retrieval.

Inverse quantization unit 42 and inverse transform unit 44 apply inverse quantization and inverse transformation, respectively, to reconstruct the residual block in the pixel domain, e.g., for later use as a reference block. The reconstructed residual block (labeled “RECON. RESID. BLOCK” in FIG. 2) may represent a reconstructed version of the residual block provided to transform unit 38. The reconstructed residual block may differ from the residual block generated by summer 48 due to loss of detail caused by the quantization and inverse quantization operations. Summer 51 adds the reconstructed residual block to the motion compensated prediction block produced by prediction unit 32 to produce a reconstructed video block for storage in memory 34. The reconstructed video block may be used by prediction unit 32 as a reference block that may be used to subsequently code a block unit in a subsequent video frame or subsequent coded unit.

In this manner, video encoder 22 represents an example of a video encoder configured to determine one or more texture components from at least a portion of an image, obtain depth information for the portion of the image, form a block unit comprising pixels of the one or more texture components and a depth component based on the depth information, and signal an attribute of the depth component relative to the one or more texture components, wherein the value for the attribute for the depth component is different from the value of the one or more texture components.

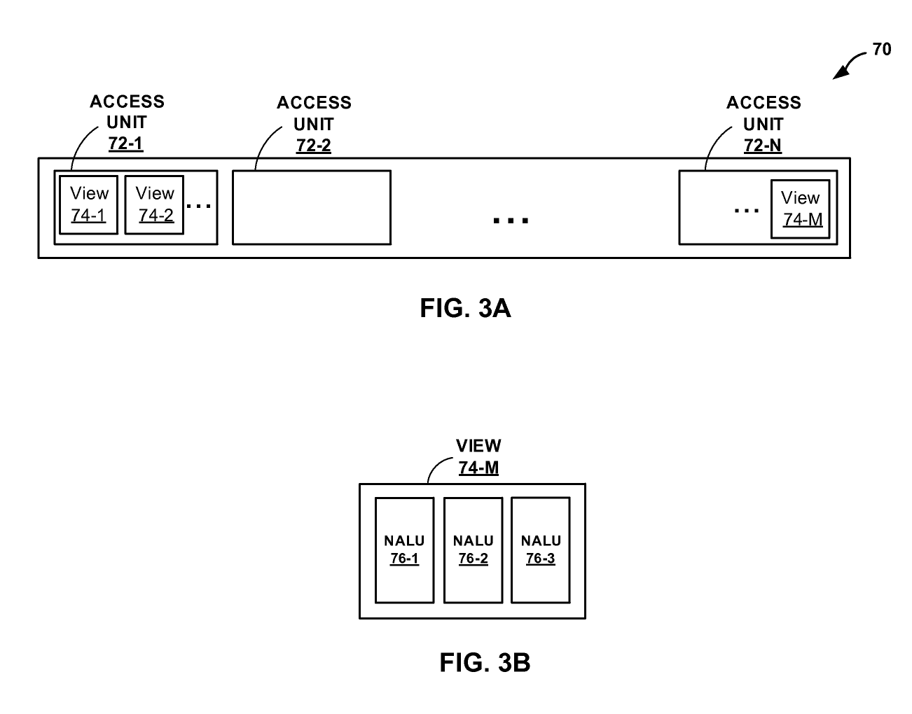

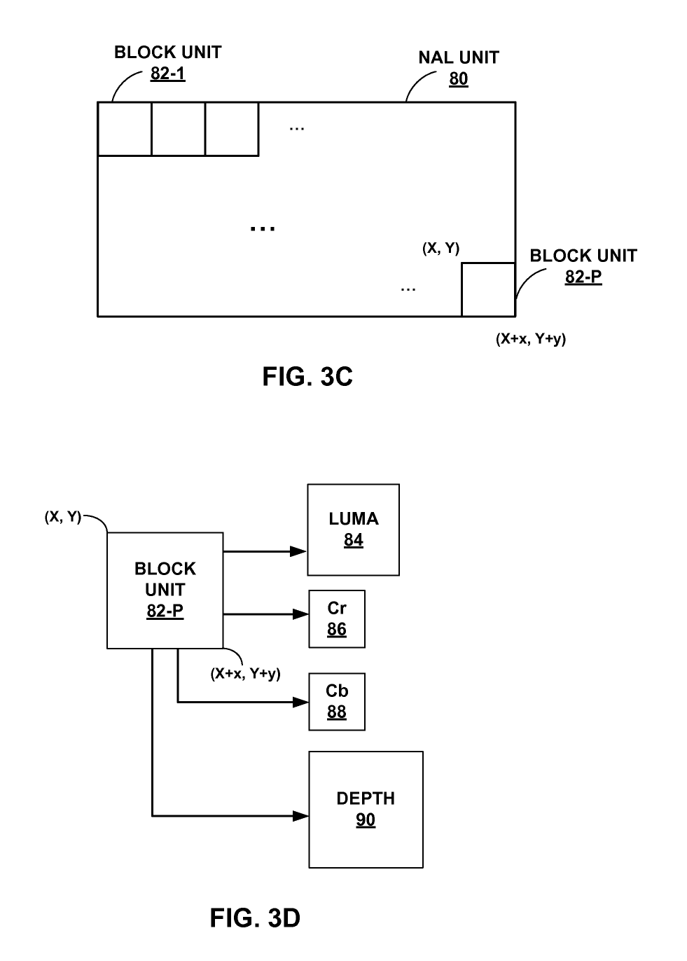

FIGS. 3A-3D are conceptual diagrams illustrating examples of elements of a bitstream structure that may be used in an implementation of one or more of the techniques of this disclosure. A bitstream may be used to transfer four-component multiview video plus depth block units and syntax elements between, for example, source device 12 and destination device 16 of FIG. 1. The bitstream may comply with the coding standard ITU H.264/AVC, and in particular, follows a multi-view video coding (MVC) bitstream structure. That is, the bitstream may conform to the MVC extension of H.264/AVC, in some examples. In other examples, the bitstream may conform to a multiview extension of HEVC or multiview extension of another standard. In still other examples, other coding standards may be used.

A typical MVC bitstream order (decoding order) arrangement is a time-first coding. Each access unit is defined to contain the coded pictures of all the views for one output time instance. The decoding order of access units may or may not be identical to the output or display order. Typically, MVC prediction may include both inter-picture prediction within each view and inter-view prediction. In MVC, the inter-view prediction may be supported by disparity motion compensation, which uses the syntax of the H.264/AVC motion compensation, but allows a picture in a different view to be used as a reference picture.

Coding of two views is supported by MVC. One of the advantages of MVC is that an MVC encoder could take more than two views as a 3D video input and an MVC decoder can decode the two views into a multi-view representation. Thus, a renderer with MVC decoder may treat 3D video content as having multiple views. Previously, MVC did not process depth map input, similar to H.264/AVC with SEI messages (stereo info. or spatial interleaving pictures).

In the H.264/AVC standard, Network Abstraction Layer (NAL) units which are defined to provide a “network-friendly” video representation addressing applications such as video telephony, storage, or streaming video. NAL units can be categorized to Video Coding Layer (VCL) NAL units and non-VCL NAL units. VCL units may contain a core compression engine and comprise block, macroblock (MB), and slice levels. Other NAL units are non-VCL NAL units.

For 2D video encoding, each NAL unit may contain a one byte NAL unit header and a payload of varying size. Five bits may be used to specify the NAL unit type. Three bits may be used for nal_ref_idc, which indicates how important the NAL unit is in terms of being referenced by other pictures (NAL units). For example, setting nal_ref_idc equal to 0 means that the NAL unit is not used for inter prediction. As H.264/AVC may be expanded to include 3D video encoding, such as the scalable video coding (SVC) standard, the NAL header may be similar to that of the 2D scenario. For example, one or more bits in the NAL unit header may be used to identify that the NAL unit is a four-component NAL unit.

NAL unit headers may also be used for MVC NAL units. However, in MVC, the NAL unit header structure may be retained except for prefix NAL units and MVC coded slice NAL units. MVC coded slice NAL units may comprise a four-byte header and the NAL unit payload, which may include a block unit such as coded block 8 of FIG. 1. Syntax elements in MVC NAL unit header may include priority_id, temporal_id, anchor_pic_flag, view_id, non_idr_flag and inter_view_flag. In other examples, other syntax elements may be included in an MVC NAL unit header.

The syntax element anchor_pic_flag may indicate whether a picture is an anchor picture or non-anchor picture. Anchor pictures and all the pictures succeeding it in the output order (i.e., display order) can be correctly decoded without decoding of previous pictures in the decoding order (i.e., bitstream order) and thus can be used as random access points. Anchor pictures and non-anchor pictures can have different dependencies, both of which may be signaled in the sequence parameter set.

The bitstream structure defined in MVC may be characterized by two syntax elements: view_id and temporal_id. The syntax element view_id may indicate the identifier of each view. This identifier in NAL unit header enables easy identification of NAL units at the decoder and quick access of the decoded views for display. The syntax element temporal_id may indicate the temporal scalability hierarchy or, indirectly, the frame rate. For example, an operation point including NAL units with a smaller maximum temporal_id value may have a lower frame rate than an operation point with a larger maximum temporal_id value. Coded pictures with a higher temporal_id value typically depend on the coded pictures with lower temporal_id values within a view, but may not depend on any coded picture with a higher temporal_id.

The syntax elements view_id and temporal_id in the NAL unit header may be used for both bitstream extraction and adaptation. The syntax element priority_id may be mainly used for the simple one-path bitstream adaptation process. The syntax element inter_view_flag may indicate whether this NAL unit will be used for inter-view predicting another NAL unit in a different view.

MVC may also employ sequence parameter sets (SPSs) and include an SPS MVC extension. Parameter sets are used for signaling in H.264/AVC. Parameter sets may contain sequence-level header information in sequence parameter sets and the infrequently changing picture-level header information in picture parameter sets (PPSs). With parameter sets, this infrequently changing information needs not to be repeated for each sequence or picture, hence coding efficiency is improved. Furthermore, the use of parameter sets enables out-of-band transmission of the header information, avoiding the need of redundant transmissions for error resilience. In some examples of out-of-band transmission, parameter set NAL units may be transmitted on a different channel than the other NAL units. In MVC, a view dependency may be signaled in the SPS MVC extension. All inter-view prediction may be done within the scope specified by the SPS MVC extension.

In some previous 3D video encoding techniques, content is coded in such a way that the color components, e.g., in the YCbCr color space, are coded in one or more NAL units while the depth image is coded in one or more separate NAL units. However, when no single NAL unit contains the coded samples of texture and depth images of an access unit, several problems may occur. For example, in a 3D video decoder, it is expected that after decoding both the texture and depth image of each frame, view rendering based on the depth map and texture is activated to generate the virtual views. If the NAL unit of the depth image and the NAL unit of the texture for an access unit are coded in a sequential manner, view rendering may not begin until the entire access unit is decoded. This may lead increase the time for the 3D video to be rendered.

Furthermore, the texture image and the associated depth map image may share some information in various levels in the codec, e.g., sequence level, picture level, slice level, and block level. Coding this information into two NAL units will take extra implementation burden when sharing or predicting the information. Thus, the encoder may have to perform motion estimation for a frame twice, once for the texture and again for the depth map. Similarly, the decoder may need to perform motion compensation twice for a frame.

As described herein, techniques may be added to existing standards, such as MVC, in order to support 3D video. Multi-view video plus depth (MVD) may be added to MVC for 3D video processing. The 3D video encoding techniques may provide more flexibility and extensibility to existing video standards, for example, for changing the view angle smoothly or adjusting the convergence or depth perception backward or forward based on the specifications of the devices or user preferences. The coding standards may also be expanded to utilize depth maps for the generation of virtual views in 3D video.

FIG. 3A is a conceptual diagram illustrating an example of a bitstream structure 70 that may be used in an implementation of one or more of the techniques of this disclosure. In FIG. 3A, bitstream 70 complies with the MVC standard after being extended to include MVD, in accordance with the techniques of this disclosure. In other examples, bitstream 70 may conform to other video encoding standards.

Bitstream 70 comprises four-component block units as well as prediction syntax elements. Bitstream 70 may comprise additional information relating to signaling of the block units. For example, bitstream 70 may include an indication of an attribute of a depth component in a block unit relative to one or more texture components in the block unit, wherein the value for the attribute for the depth component is different from the value of the one or more texture components. For example, bitstream 70 may include an attribute of depth information 6 relative to one or more texture components 4 that is a resolution of the depth information 6 relative to a resolution of the one or more texture components 4. In other examples, bitstream 70 may signal a quantization parameter difference between the depth component and one of the one or more texture components. In yet further example, bitstream 70 may signal a delta quantization parameter for the depth component. One or more of these or other attributes may be included in bitstream 70.

The attributes included in bitstream 70 may be provided in one of a prediction unit level, a coding unit level, a frame level, a slice level, or a sequence level, wherein each level is related to the current block of pixels (for example, image 2). In some examples, the attributes may be indicated in a sequence parameter set (SPS) or picture parameter set (PPS).

As shown in FIG. 3A, bitstream 70 comprises a plurality of access units 72-1 through 72-N. Access units comprise a set of view components (referred to as views for convenience below), such as views 74-1 through 74-M. In general, access units include all data for a common temporal instance, e.g., data for one view component per view. In some examples, each access unit 72-1 through 72-N comprises the same number of views 74-1 through 74-M (referred to as a view 74). Decoding each access unit may result in one decoded picture per view. Access units 72-1 through 72-N may contain encoded video data that may be used to render three-dimensional video playback. In accordance with the techniques of this disclosure, the view components of the access units may include four component block units, that is, block units having three texture components (luminance and chrominance) and a depth component.

FIG. 3B is a conceptual diagram illustrating an example of a view 74-M that may be included in the structure of the bitstream 70 of FIG. 3A. Each view component in an access unit (such as view 74-1 in access unit 72-1) contains a set of video codec layer (VCL) NAL units 76-1 through 76-3. View 74-M comprises NAL units 76-1 through 76-3 in a specific form and order. Typically, the view components are arranged in the same order in each access unit, such that the kth view component in each access unit corresponds to the same view. In other examples, view 74-M comprises other numbers of NAL units.

FIG. 3C is a conceptual diagram illustrating an example of a NAL unit 80 that may be included in the structure of the bitstream 70 of FIG. 3A. NAL unit 80 corresponds to a portion of an image, such as image 2. That is, a VCL NAL unit typically includes data for one slice of an image (where in some cases, the slice may correspond to the full image). The structure of NAL unit 80 defines a signal format for use in transport systems, such as bitstream 70. The first byte of NAL unit 80 may be a header byte that contains an indication of the type of data in NAL unit 80. The remaining bytes in NAL unit 80 may contain payload data of the type indicated by the header, such as encoded four-component video data.

NAL unit 80 comprises a plurality of coded blocks 82-1 through 82-P (referred to collectively as coded blocks “82”), where P is an integer. The coded blocks 82 each comprise coded video data for a portion of a view component. For example, coded block 82-P is a portion of a slice (stored within one of NAL units 76, for example) of a view component (e.g., one of views 74) of one of access units 72. There may be a coded block for each portion of the slice.

Coded blocks 82 may be four-component coded blocks, as discussed below with respect to FIG. 3D. Each coded block 82 may be associated with cartesean coordinates of NAL unit 80 (that is, the image or view that coded block 82 are formed from). For example, an upper right pixel of coded block 82-P may be at location (X, Y) of NAL unit 80. Coded block 82-P may be x pixels wide and y pixels tall. Thus, a lower left pixel of coded block 82-P is at location (X+x, Y+y).

FIG. 3D is a conceptual diagram illustrating an example of coded block 82-P that may be included in the structure of the bitstream 70 of FIG. 3A. Coded block may be any coded video unit, such as but not limited to, macroblocks according to the H.264/AVC standard or Coding Units according to the HEVC standard.

Coded block 82-P comprises four components. These components include three texture components of luminance and chrominance in coded block 82-P. The texture components include luma (Y) component 84, Cr component 86, and Cb component 88. Coded block 82-P also includes a depth component 90 for each pixel location. Depth component 90 may be extracted from a depth map corresponding to the view or image. In this manner, 3D video content may be represented, for example, as multiview video plus depth coded blocks. That is, each view component may include texture data for one view, as well as depth information that can be used to generate a virtual view from the texture data.

Bitstream 70 may be transferred to a receiver, such as receiver 26, in a bitstream including signaling information along with coded block 82-P. In addition to coded blocks 82, bitstream 70 may include attributes of the depth component relative to the one or more texture components. Bitstream 70 may also include blocks of residual data, motion vectors (when inter-prediction encoded), indications of intra-prediction modes for intra-prediction, attributes of depth components relative to texture components, and possibly other data, such as types of syntax elements.

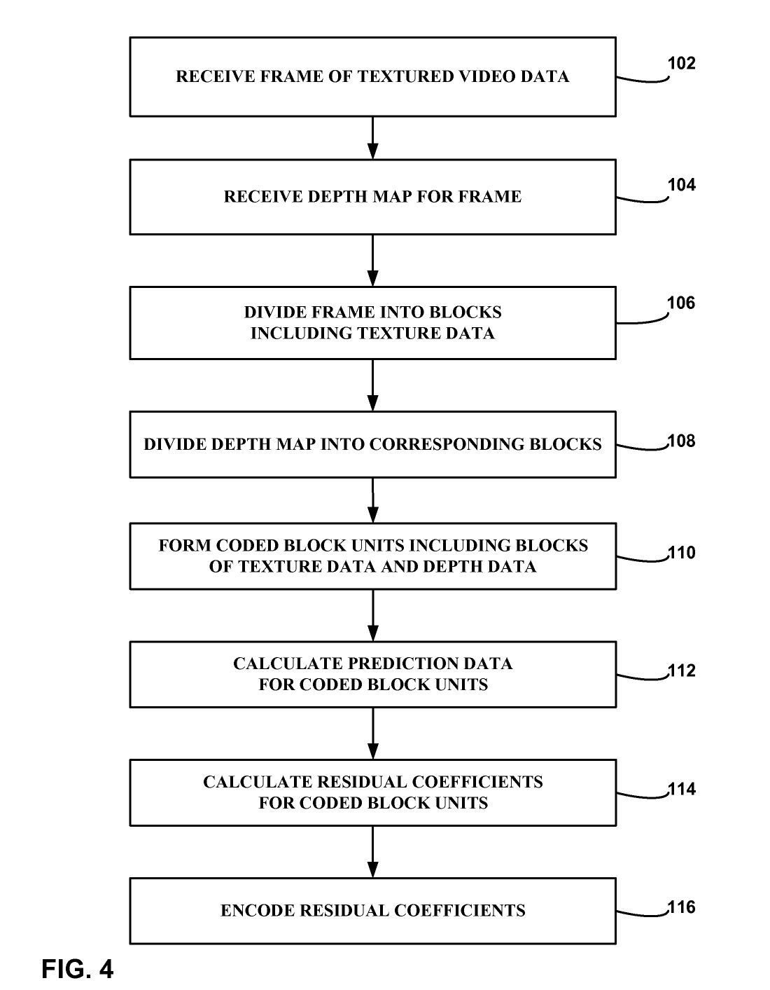

FIG. 4 is a flow diagram illustrating an example operation of a video encoder consistent with this disclosure. The technique of FIG. 4 will be described from the perspective of video encoder 22 of FIG. 2, although other devices may perform similar techniques.

Video encoder 22 may obtain a frame of textured video data (102). A frame may be at least a portion of an image. The textured video data may have luma components and chroma components. Video encoder 22 may further obtain a depth map corresponding to the frame (104). The depth map may include depth information for regions of pixels in the video frame. The depth map may have the same or a different resolution than that of the texture components.

Video encoder 22 may divide the frame into blocks that include texture data (106). The depth map may be similarly divided into corresponding blocks by the video encoder 22 (108). From the blocks including texture data and the blocks including depth data, video encoder 22 may form coded blocks including blocks of both texture data and depth data (110).

Once the coded blocks are formed, video encoder 22 may calculate prediction data for the coded blocks (112). The prediction data may be separate for the texture and depth components. Video encoder 22 may calculate residual coefficients for the coded blocks (114). Video encoder 22 may then encode the residual coefficients (116). The encoded residual coefficients may be transmitted to a decoder device (such as decoder 28) in an encoded bitstream.

FIG. 5 is a flow diagram illustrating an example operation of a video encoder that utilizes four component coded blocks consistent with this disclosure. The technique of FIG. 4 will be described from the perspective of video encoder 22 of FIG. 2, although other devices may perform similar techniques. At least part of the method shown in FIG. 5 may correspond to part of the method shown in FIG. 4. For example, steps 120 through 124 of FIG. 5 may correspond to steps 102 through 110 of FIG. 4.

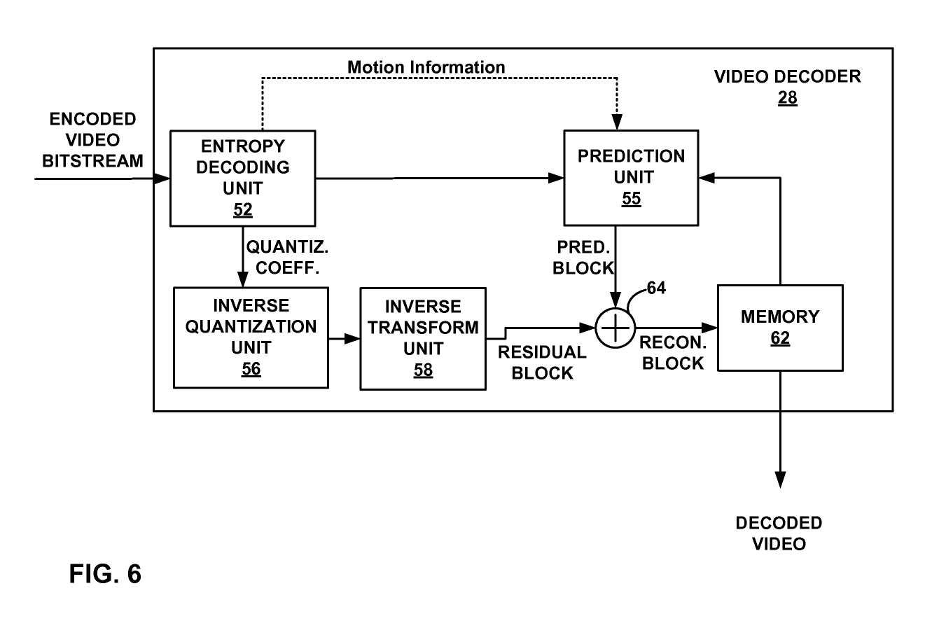

Video encoder 22 may receive one or more texture components from at least a portion of an image representing a view of three dimensional video data (120). Video encoder 22 may receive a depth map component for at least the portion of the image (122). Using the depth information, video encoder 22 may also code a coded block comprising pixels of the one or more texture components for a portion of the image and the depth map component, wherein coding comprises coding the depth map component relative to at least one of the texture components (124). Video encoder 22 may also generate or signal an attribute of the depth map component relative to the one or more texture components, wherein the value for the attribute for the depth map component is different from the value of the one or more texture components (126). Techniques similar to the example operation of video encoder 22 described with respect to FIG. 4 will be explained further in FIG. 6.

The attribute of the depth component relative to the one or more texture components may be a resolution of the depth component relative to a resolution of the one or more texture components. In another example, the attribute of the depth component relative to the one or more texture components may be a quantization parameter difference between the depth component and one of the one or more texture components or a delta quantization parameter for the depth component. In some examples, one or more of these attributes may be signaled with the coded block.

The technique described in FIG. 5 may also include determining a quantization matrix for a depth image coding residue of the depth component. An indication of the quantization matrix may be provided in at least a slice header of a slice unit related to the coded block. The technique may also include determining deblocking information for the depth component and providing an indication of the deblocking information in a picture parameter set of a picture associated with the coded block. In other examples, the technique may also include determining block level information for pixels of the one or more texture components, wherein the depth component shares the block level information.

FIG. 6 is a block diagram illustrating an example of a video decoder 28, which may decode a video sequence that is encoded in the manner described herein. Video decoder 28 is one example of a specialized video computer device or apparatus referred to herein as a “coder.” As shown in FIG. 6, video decoder 28 corresponds to video decoder 28 of destination device 16. However, in other examples, video decoder 28 may correspond to a different device. In further examples, other units (such as, for example, other encoder/decoder (CODECS)) can also perform similar techniques as video decoder 28.

Video decoder 28 includes an entropy decoding unit 52 that entropy decodes the received bitstream to generate quantized coefficients and the prediction syntax elements. The bitstream may include four component coded blocks having texture components and a depth component for each pixel location in order to render a 3D video. The prediction syntax elements may include a coding mode, one or more motion vectors, information identifying an interpolation technique used, coefficients for use in interpolation filtering, attribute of the depth component relative to the one or more texture components, and/or other information associated with the generation of the prediction block. The attribute of the depth component relative to the one or more texture components may be a resolution of the depth component relative to a resolution of the one or more texture components, a quantization parameter difference between the depth component and one of the one or more texture components, or a delta quantization parameter for the depth component.

The prediction syntax elements, e.g., the coefficients, are forwarded to prediction unit 55. If prediction is used to code the coefficients relative to coefficients of a fixed filter, or relative to one another, prediction unit 55 can decode the syntax elements to define the actual coefficients. Also, if quantization is applied to any of the prediction syntax, inverse quantization unit 56 may also remove such quantization. Inverse quantization unit 56 may treat the depth and texture components for each pixel location of the coded blocks in the encoded bitstream differently. For example, the depth component may have been quantized differently than the texture components. Therefore, inverse quantization unit 56 may process the depth and texture components separately. Filter coefficients, for example, may be predictively coded and quantized according to this disclosure, and in this case, inverse quantization unit 56 may be used by video decoder 28 to predictively decode and de-quantize such coefficients.

Prediction unit 55 may generate prediction data based on the prediction syntax elements and one or more previously decoded blocks that are stored in memory 62, in much the same way as described in detail above with respect to prediction unit 32 of video encoder 22. In particular, prediction unit 55 may perform one or more of the multi-view video plus depth techniques of this disclosure during motion compensation to generate a prediction block incorporating depth components as well as texture components. The prediction block (as well as a coded block) may have different resolution for the depth components versus the texture components. For example, the depth components may have quarter-pixel precision while the texture components have full-integer pixel precision. As such, one or more of the techniques of this disclosure may be used by video decoder 28 in generating a prediction block. Prediction unit 55 may include a motion compensation unit that comprises filters used for interpolation and interpolation-like filtering techniques of this disclosure. The motion compensation component is not shown in FIG. 6 for simplicity and ease of illustration.

Inverse quantization unit 56 inverse quantizes, i.e., de-quantizes, the quantized coefficients. The inverse quantization process may be a process defined for H.264 decoding or for any other decoding standard. Inverse transform unit 58 applies an inverse transform, e.g., an inverse DCT or conceptually similar inverse transform process, to the transform coefficients in order to produce residual blocks in the pixel domain. Summer 64 sums the residual block with the corresponding prediction block generated by prediction unit 55 to form a reconstructed version of the original block encoded by video encoder 22. If desired, a deblocking filter may also be applied to filter the decoded blocks in order to remove blockiness artifacts. The decoded video blocks are then stored in memory 62, which provides reference blocks for subsequent motion compensation and also produces decoded video to drive display device (such as device 28 of FIG. 1).

The decoded video may be used to render 3D video. The 3D video may comprise a three dimensional virtual view. Depth information may be used to determine a horizontal offset (horizontal disparity) for each pixel in the block. Occlusion handling can also be performed to generate the virtual view.

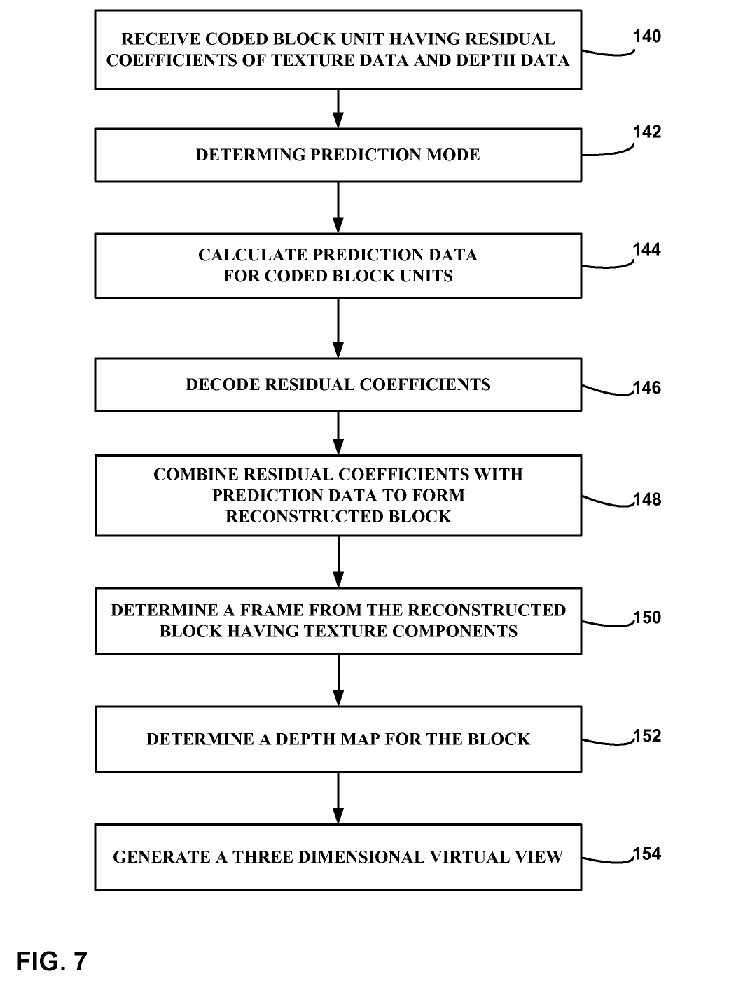

FIG. 7 is a flow diagram illustrating an example operation of a video decoder consistent with this disclosure. Thus, the process of FIG. 7 may be considered the reciprocal decoding process to the encoding process of FIG. 4. FIG. 7 will be described from the perspective of video decoder 28 of FIG. 6 although other devices may perform similar techniques.

Video decoder 28 receives a coded block having residual coefficients of texture data and depth data (160). The texture data includes information for the luma and chroma of each pixel of an image block corresponding to the coded block. The depth data includes depth information from a depth map for a region of pixels. The depth information may have a different resolution than the luma and chroma components.

Video decoder 28 determines a prediction mode in order to know what prediction block the residual coefficients were determined from in the encoder (such as video encoder 22) (162). Knowing the prediction mode, video decoder 28 may calculate prediction data for the coded blocks (164). Video decoder 28 may decode the residual coefficients (166). The residual coefficients may be inverse quantized (for example, by inverse quantization unit 56) and inverse transformed (for example, by inverse transform unit 58).

Using the decoded residual coefficients, video decoder 28 may combine the residual coefficients with the prediction data to form a reconstructed block (148). From the reconstructed block, video decoder 28 may generate a frame of the image having texture components (150). Also from the reconstructed block, video decoder 28 may determine a depth map for the block (152).

Using the frame having texture components and the depth map, video decoder 28 may generate a three dimensional virtual view of the frame (154). The frame may be combined with other decoded frames to generate a three dimensional virtual view of an image. In some examples, video decoder 28 does not generate the three dimensional virtual view, but rather forwards the frame having the texture components and a depth map to an external rendering device.

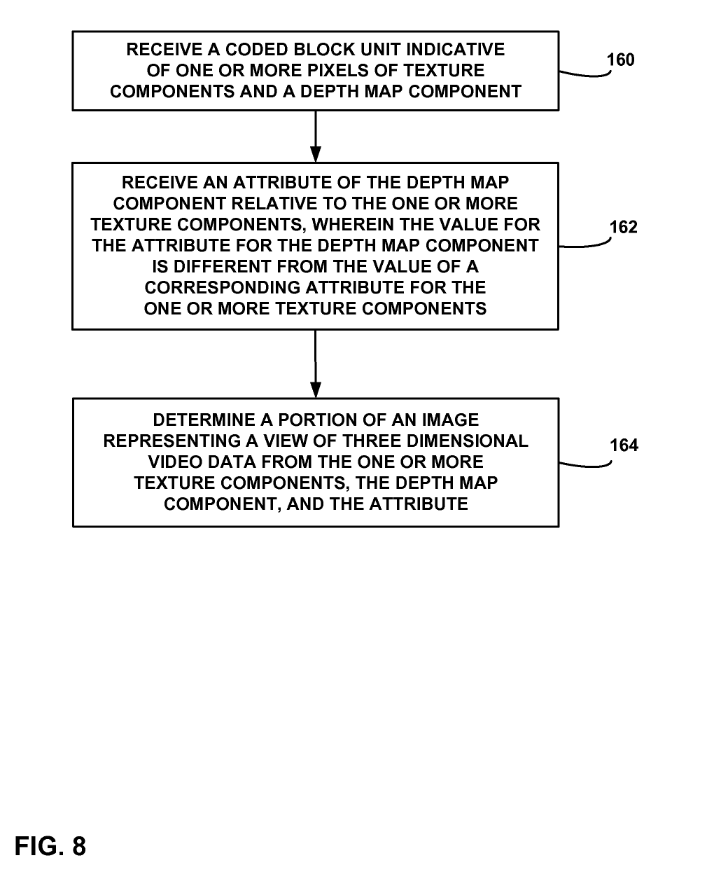

FIG. 8 is a flow diagram illustrating an example operation of a video decoder that utilizes filter support consistent with this disclosure. Thus, the process of FIG. 8 may be considered the reciprocal decoding process to the encoding process of FIG. 5. FIG. 8 will be described from the perspective of video decoder 28 of FIG. 6 although other devices may perform similar techniques. At least part of the method shown in FIG. 8 may correspond to part of the method shown in FIG. 7. For example, steps 160 through 164 of FIG. 8 may correspond to steps 140 through 152 of FIG. 7.

Video decoder 28 may receive a coded block including indications of pixels of one or more texture components and a depth map component (160). In one example, video decoder 28 receives the coded block or reference sample from a video encoder, such as video encoder 22. Video decoder 28 may also receive an attribute of the depth map component relative to the one or more texture components, wherein the value for the attribute for the depth map component is different from the value of a corresponding attribute for the one or more texture components (162). In some examples, the value for the attribute for the depth component is different from the value of the one or more texture components. Video decoder 28 may determine a portion of an image representing a view of three dimensional video data from the one or more texture components, the depth map component, and the attribute (164).

Video decoder 28 may decode the block unit according to the High Efficient Video Coding (HEVC) standard. In another example, video decoder 28 may decode the block unit according to ITU-T H.264/AVC standard, especially the scalable video coding (SVC) standard of the H.264/AVC standard.

The attribute received by video decoder 28 may be a resolution of the depth component relative to a resolution of the one or more texture components, a quantization parameter difference between the depth component and one of the one or more texture components, or a delta quantization parameter for the depth component. In some examples, video decoder 28 receives more than one attribute of the depth component relative to one or more of the texture components.

The technique described in FIG. 8 may also include receiving an indication of a quantization matrix in at least a slice header of a slice unit related to the coded block. From the indication, a quantization matrix may be determined for a depth image coding residue of the depth component. The technique may further include receiving an indication of deblocking information in a picture parameter set of a picture including the coded block and deblocking the depth component based on the deblocking information. In another example, the technique may further include receiving, at video encoder 28, block level information for pixels of the one or more texture components, wherein the depth component shares the block level information.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of this disclosure have been described. These and other examples are within the scope of the following claims.

1. A method of processing video data, the method comprising:
receiving a coded block unit indicative of pixels of one or more texture components and a depth map component;
receiving an attribute of the depth map component relative to the one or more texture components, wherein the value for the attribute for the depth map component is different from the value of a corresponding attribute for the one or more texture components; and
determining a portion of an image representing a view of three dimensional video data from the one or more texture components, the depth map component, and the attribute.

2. The method of claim 1, wherein the attribute comprises a resolution of the depth map component relative to a resolution of at least one of the one or more texture components for an entire coded video sequence, for a group of pictures, or for a slice.

3. The method of claim 1, wherein the attribute comprises a quantization parameter difference between the depth map component and one of the one or more texture components for a slice.

4. The method of claim 1, wherein the attribute comprises a flag in the slice level indicating whether the depth map component is present.

5. The method of claim 1, further comprising:
receiving an indication of a quantization matrix and an indication that the quantization matrix applies to the depth map component of at least one of the coded video sequence of the view, a group of pictures of a view, or a slice; and
from the indication, determining the quantization matrix for a depth image coding residue of the depth map component.

6. The method of claim 1, further comprising:
receiving an indication of deblocking information for the depth map component in a slice level; and
deblocking the depth map component based on the deblocking information.

7. The method of claim 1, further comprising:
receiving block level information for the pixels of the one or more texture components; and
receiving block level information for the depth map component that is different from the block level information of the one or more texture components.

8. The method of claim 7, further comprising:
receiving a coded block unit pattern for the depth map component to indicate for the coded block unit whether one of all depth map transform coefficients are zero, only DC coefficients are non-zero, or some AC coefficients are non-zero;
receiving a motion vector difference between the one or more texture components and the coded depth map component; and
receiving a quantization parameter difference between the coded depth map component and the one or more texture components.

9. A device for decoding data, comprising a video decoder configured to:
receive a coded block unit indicative of pixels of one or more texture components and a depth map component;
receive an attribute of the depth map component relative to the one or more texture components, wherein the value for the attribute for the depth map component is different from the value of a corresponding attribute for the one or more texture components; and
determine a portion of an image representing a view of three dimensional video data from the one or more texture components, the depth map component, and the attribute.

10. The device of claim 9, wherein the attribute comprises a resolution of the depth map component relative to a resolution of at least one of the one or more texture components for an entire coded video sequence, for a group of pictures, or for a slice.

11. The device of claim 9, wherein the attribute comprises a quantization parameter difference between the depth map component and one of the one or more texture components for a slice.

12. The device of claim 9, wherein the attribute comprises a flag in the slice level indicating whether the depth map component is present.

13. The device of claim 9, wherein the device is further configured to:
receive an indication of a quantization matrix and an indication that the quantization matrix applies to the depth map component of at least one of the coded video sequence of the view, a group of pictures of a view, or a slice; and
from the indication, determining the quantization matrix for a depth image coding residue of the depth map component.

14. The device of claim 9, wherein the device is further configured to:
receive an indication of deblocking information for the depth map component in a slice level; and
deblock the depth map component based on the deblocking information.

15. A computer program product comprising a computer-readable storage medium having stored thereon instructions that, when executed, cause a processor of a video decoding device to:
receive a coded block unit indicative of pixels of one or more texture components and a depth map component;
receive an attribute of the depth map component relative to the one or more texture components, wherein the value for the attribute for the depth map component is different from the value of a corresponding attribute for the one or more texture components; and
determine a portion of an image representing a view of three dimensional video data from the one or more texture components, the depth map component, and the attribute.

16. The computer-readable storage medium of claim 15, wherein the attribute comprises a resolution of the depth map component relative to a resolution of at least one of the one or more texture components for an entire coded video sequence, for a group of pictures, or for a slice.

17. The computer-readable storage medium of claim 15, wherein the attribute comprises a quantization parameter difference between the depth map component and one of the one or more texture components for a slice.

18. The computer-readable storage medium of claim 15, wherein the attribute comprises a flag in the slice level indicating whether the depth map component is present.

19. The computer-readable storage medium of claim 15, wherein the device is further configured to:
receive an indication of a quantization matrix and an indication that the quantization matrix applies to the depth map component of at least one of the coded video sequence of the view, a group of pictures of a view, or a slice; and
from the indication, determine the quantization matrix for a depth image coding residue of the depth map component.

20. The computer-readable storage medium of claim 15, wherein the device is further configured to:
receive an indication of deblocking information for the depth map component in a slice level; and
deblock the depth map component based on the deblocking information.

21. A device for processing video data, comprising:
means for receiving a coded block unit indicative of pixels of one or more texture components and a depth map component;
means for receiving an attribute of the depth map component relative to the one or more texture components, wherein the value for the attribute for the depth map component is different from the value of a corresponding attribute for the one or more texture components; and
means for determining a portion of an image representing a view of three dimensional video data from the one or more texture components, the depth map component, and the attribute.

22. The device of claim 21, wherein the device further comprises:
means for receiving an indication of a quantization matrix and an indication that the quantization matrix applies to the depth map component of at least one of the coded video sequence of the view, a group of pictures of a view, or a slice; and
means for determining, from the indication, the quantization matrix for a depth image coding residue of the depth map component.

23. A method of processing video data, the method comprising:
receiving pixels of one or more texture components from at least a portion of an image representing a view of three dimensional video data;
receiving a depth map component for at least the portion of the image;
coding a block unit indicative of the pixels of the one or more texture components for a portion of the image and the depth map component, wherein coding comprises coding the depth map component relative to at least one of the texture components; and
signaling an attribute of the depth map component relative to the one or more texture components, wherein the value for the attribute for the depth map component is different from the value of the one or more texture components.

24. The method of claim 23, wherein the attribute comprises a resolution of the depth map component relative to a resolution of at least one of the one or more texture components for an entire coded video sequence, for a group of pictures, or for a slice.

25. The method of claim 23, wherein the attribute comprises a quantization parameter difference between the depth map component and one of the one or more texture components for a slice.

26. The method of claim 23, wherein the attribute comprises a flag in the slice level indicating whether the depth map component is present.

27. The method of claim 23, further comprising:
determining a quantization matrix for a depth image coding residue of the depth map component; and
providing an indication of the quantization matrix and an indication that the quantization matrix applies to the depth map components of at least one of the coded video sequence of the view, a group of pictures of a view, or a slice.

28. The method of claim 23, further comprising:
determining deblocking information for the depth map component; and
providing an indication of the deblocking information for the depth map component in a slice level.

29. The method of claim 23, further comprising:
determining block level information for the pixels of the one or more texture components;
determining block level information for the depth map component;
determining what block level information is shared by the depth map component and the texture components; and
signaling the block level information for the depth map component that is different from the block level information of the one or more texture components.

30. The method of claim 23, further comprising:
signaling a coded block pattern for the depth map component to indicate for the coded block unit whether one of all depth map transform coefficients are zero, only DC coefficients are non-zero, or some AC coefficients are non-zero;
signaling a motion vector difference between the one or more texture components and the coded depth map component; and
signaling a quantization parameter difference between the coded depth map component and the one or more texture components.

31. A device for encoding data, comprising a video encoder configured to receive pixels of one or more texture components from at least a portion of an image representing a view of three dimensional video data, receive a depth map component for at least the portion of the image, code a block unit indicative of the pixels of the one or more texture components for a portion of the image and the depth map component, wherein coding comprises coding the depth map component relative to at least one of the texture components, and signal an attribute of the depth map component relative to the one or more texture components, wherein the value for the attribute for the depth map component is different from the value of the one or more texture components.

32. The device of claim 31, wherein the attribute comprises a resolution of the depth map component relative to a resolution of at least one of the one or more texture components for an entire coded video sequence, for a group of pictures, or for a slice.

33. The device of claim 31, wherein the attribute comprises a quantization parameter difference between the depth map component and one of the one or more texture components for a slice.

34. The device of claim 31, wherein the attribute comprises a flag in the slice level indicating whether the depth map component is present.

35. The device of claim 31, wherein the video encoder is configured to determine a quantization matrix for a depth image coding residue of the depth map component, and provide an indication of the quantization matrix and an indication that the quantization matrix applies to the depth map components of at least one of the coded video sequence of the view, a group of pictures of a view, or a slice.

36. The device of claim 31, wherein the video encoder is configured to determine deblocking information for the depth map component, and provide an indication of the deblocking information for the depth map component in a slice level.

37. The device of claim 31, wherein the video encoder is configured to determine block level information for the pixels of the one or more texture components, determine block level information for the depth map component, determine what block level information is shared by the depth map component and the texture components, and signal the block level information for the depth map component that is different from the block level information of the one or more texture components.

38. A computer program product comprising computer-readable storage medium having stored thereon instructions that, when executed, cause a processor of a video coding device to:
receive pixels of one or more texture components from at least a portion of an image representing a view of three dimensional video data;
receive a depth map component for at least the portion of the image;
code a block unit indicative of the pixels of the one or more texture components for a portion of the image and the depth map component, wherein coding comprises coding the depth map component relative to at least one of the texture components; and
signal an attribute of the depth map component relative to the one or more texture components, wherein the value for the attribute for the depth map component is different from the value of the one or more texture components.

39. The computer-readable storage medium of claim 38, wherein the attribute comprises a resolution of the depth map component relative to a resolution of at least one of the one or more texture components for an entire coded video sequence, for a group of pictures, or for a slice.

40. The computer-readable storage medium of claim 38, wherein the attribute comprises a quantization parameter difference between the depth map component and one of the one or more texture components for a slice.

41. The computer-readable storage medium of claim 38, wherein the attribute comprises a flag in the slice level indicating whether the depth map component is present.

42. The computer-readable storage medium of claim 38, wherein the instructions further cause the video coding device to:
determine a quantization matrix for a depth image coding residue of the depth map component; and
provide an indication of the quantization matrix and an indication that the quantization matrix applies to the depth map components of at least one of the coded video sequence of the view, a group of pictures of a view, or a slice.

43. A device for processing video data, comprising:
means for receiving pixels of one or more texture components from at least a portion of an image representing a view of three dimensional video data;
means for receiving a depth map component for at least the portion of the image;
means for coding a block unit comprising the pixels of the one or more texture components for a portion of the image and the depth map component, wherein coding comprises coding the depth map component relative to at least one of the texture components; and
means for signaling an attribute of the depth map component relative to the one or more texture components, wherein the value for the attribute for the depth map component is different from the value of the one or more texture components.

44. The device of claim 43, further comprising:
means for determining a quantization matrix for a depth image coding residue of the depth map component; and
means for providing an indication of the quantization matrix and an indication that the quantization matrix applies to the depth map components of at least one of the coded video sequence of the view, a group of pictures of a view, or a slice.

45. The device of claim 43, further comprising:
means for determining deblocking information for the depth map component; and
means for providing an indication of the deblocking information for the depth map component in a slice level.
